(19) United States
(12) Patent Application Publication
(10) Pub. No.: US 2015/0376441 A1
(43) Pub. Date: Dec. 31, 2015

(54) MESOPOROUS INORGANIC COATINGS WITH PHOTOCATALYTIC PARTICLES IN ITS PORES

(71) Applicant: CAMBRIDGE ENTERPRISE LIMITED, Cambridge (GB)

(72) Inventors: Stefan Guldin, Markdort (DE); Ullrich Steiner, Bern (CH)

(21) Appl. No.: 14/592,073

(22) Filed: Jan. 8, 2015

Related U.S. Application Data
(63) Continuation of application No. PCT/GB2013/051841, filed on Jul. 11, 2013.

(30) Foreign Application Priority Data
Jul. 11, 2012 (GB) 1212361.8

(51) Int. Cl. C09D 153/00; G02B 1/18; B05D 5/08; G02B 1/111; C09D 5/00; B05D 1/00

(52) U.S. Cl. CPC C09D 153/00; C09D 5/006; B05D 1/005; B05D 5/08; G02B 1/111; G02B 1/18

(57) ABSTRACT

This invention relates to coatings for substrates, in particular antireflective coatings (ARCs) and self-cleaning coatings (SCCs). A coating for a substrate comprises a mesoporous inorganic skeleton having photocatalytic particles provided therein and/or thereon, the coating having a porosity in excess of 50 v/v %, for example, greater than 55%, 60%, 65%, 70 v/v %.

### CROSS-REFERENCE TO RELATED APPLICATIONS

This application is a continuation of and claims the benefit of priority of International Application No. PCT/GB2013/051841, filed Jul. 11, 2013, which in turn claims the benefit of priority to GB application number 1212361.8, filed Jul. 11, 2012.

### BACKGROUND

1. Field of the Disclosure

This invention relates to coatings for substrates, in particular antireflective coatings (ARCs) and self-cleaning coatings (SCCs). The invention is particularly concerned with a coating which is both an ARC and an SCC, which we term a self-cleaning antireflective coating (SCARC).

2. Description of Related Art

Since the first experimental approaches to the reduction of light reflection from optical interfaces, works have sought to continuously optimize the performance of antireflection coatings. Whilst the physical requirements have long been understood, the implementation of broad-band anti reflective coatings on low index substrates remains a challenge. Anti-reflectivity is achieved by destructive interference of light reflected from the two (or more) interfaces of thin film optical coatings. Two conditions have to be fulfilled for a single layer ARC: (1) Phase matching for destructive interference requires an optical layer thickness dₐ, of a quarter wavelength of the incident light λ: nₐᵣdₐᵣ=λ/4. (2) Complete destructive interference requires identical amplitudes of the reflected beams from both interfaces, requiring: nₐᵣ=(nₒnₛ)^{0.5} with nₐᵣ, nₒ, nₛ being the refractive indices of the ARC, the medium and the substrate, respectively.

While the first condition is easily met with modern deposition techniques, the second condition poses a challenge: many transparent materials have a refractive index around 1.5, requiring nₐᵣ≈1.22. The commonly used magnesium fluoride with n=1.37 fulfils condition (2) only for extremely high refractive index substrates (nₛ≈1.9) and yields a much lower optical performance for commonly used glasses and transparent plastics.¹ ¹ Macleod, H. Thin film optical filters. Institute of Physics Publishing, 3^{rd} Edition, (2001).

The manufacture of ARCs on common optical substrates requires a decrease in nₐᵣ. Because of the lack of transparent optical materials with sufficiently low refractive index, this can only be achieved by the introduction of voids with sub-wavelength dimensions into the layer. The effective refractive index of such material-air composites can be approximated by various effective medium theories^{2,3}, such as the Bruggeman model Whilst research-grade nanostructured ARCs are close to perfection, their implementation in commercial products is hampered by their lack of wear resistance and optical variability caused by contamination of the nanostructure. In particular for outdoor applications, ARCs need to be structurally resistant and should recover from ambient pollution. The latter can in principle be implemented through self-cleaning ARCs based on surface super-hydrophobicity or photocatalysis.³ ² Bergman, D. and Stroud, D. in Solid State Physics: Advances in Research And Applications, Vol 46, Volume 46 of Solid State Physics-Advances in Research And Applications, 147-269. Academic Press Inc (1992).³ Parkin, I. P. and Palgrave, R. G. Journal of Materials Chemistry 15, 1689-1695 (2005).

Superhydrophobic surfaces are self-cleaning in a sense that particulate contaminants adhere only very weakly and are easily washed off by water. Photocatalytic coatings, on the other hand, do not rely on a cleaning medium, but rather decompose organic contaminants by light-induced redox-reactions. While photocatalytic self-cleaning is in principle more robust, the inclusion of a photocatalytic component in ARCs, typically TiO₂, poses a major challenge because of the high refractive index of (n_{TiO2}>(2.5).

Several solutions have been proposed to combine self-cleaning and antireflection, including the surface coating of a colloidal-based ARC with TiO₂,⁴ the co-deposition of TiO₂ and SiO₂ nanoparticles to form a porous ARC,⁵, and a double layer structure of low refractive index SiO₂ and TiO₂.^{6,7} All of these approaches require a high temperature processing step, which prevents their use on flexible, plastic-based substrates. Furthermore, the nanometre scale structure of the above-identified proposals limits the achievable porosity and thus the volume fraction of TiO₂ that can be incorporated without compromising the required effective refractive index of the coating. ⁴ Zhang, X.-T., Sato, O., Taguchi, M., Einaga, Y., Murakami, T., and Fujishima, A. Chemistry of Materials 17(3), 696-700 (2005).⁵ Lee, D., Rubner, M. F., and Cohen, R. E. Nano letters 6(10), 2305-12 (2006).⁶ Zhang, X., Fujishima, A., Jin, M., Emeline, A. V., and Murakami, T. Journal Of Physical Chemistry 8 110(50), 25142-25148 (2006).⁷ Faustini, M., Nicole, L., Bolssiere, C., Innocenzi, P., Sanchez, C., and Grosso, D. Chemistry Of Materials 22(15), 4406-4413 (2010).

### SUMMARY OF THE DISCLOSURE

It is an object of the current invention to provide a coating which has antireflective properties and which is self-cleaning, but which does not suffer from the limitations of the prior art proposals. In particular, it is an object of the invention to provide a SCARC which has effective anti-reflective properties, as determined at least in part by a sufficiently low refractive index and which has effective self-cleaning properties and which is capable of being applied to a wide range of substrates.

Accordingly, a first aspect of the invention provides a coating for a substrate, the coating comprising a porous, preferably mesoporous, inorganic skeleton having photocatalytic particles provided therein and/or thereon.

A second aspect of the invention provides a coating for a substrate, the coating comprising a highly porous skeleton made of a transparent material with structure on the sub-optical length scale, having photocatalytic particles provided therein and/or thereon.

A third aspect of the invention provides a SCARC, the coating comprising a transparent matrix material of low refractive index, and a photocatalyst and having an optical transmittance in excess of 90% from 400 to 900 nm on a transparent substrate at a thickness of from, say 80 to 150 nm, e.g. approx. 110 nm, and having a refractive index of less than 1.3 in the said wavelength range.

A fourth aspect of the invention provides a SCARC, the coating comprising an inorganic material, for example a silica-containing material such as an aluminosilicate, and titania and having an optical transmittance in excess of 90% from 400 to 900 nm on a transparent substrate at a thickness of from 80 to 150 nm, say about 110 nm, and having a refractive index of less than 1.3 at 632 nm.

There is further provided a precursor mixture for a SCARC, the mixture comprising:
A solution of a sacrificial polymer
A precursor material comprising species formable into an inorganic skeleton
Photocatalytic nanocrystals

A yet further aspect of the invention provides a method of making an SCARC, the method comprising the steps of:

a) Combining to form a mixture
A solution of a sacrificial polymer
A precursor material formable into an inorganic skeleton
Photocatalytic nanocrystals

b) Solution processing the mixture to provide a coating on a substrate, and

c) Annealing or curing the coating.

There is further provided a method of tuning the refractive index of a SCARC, the method comprising combining to form a mixture:
A solution of a sacrificial polymer (component A)
A precursor material formable into an inorganic skeleton (component B)
Photocatalytic nanocrystals (component C)
   and increasing the weight ratio of A:(B+C) and/or decreasing the weight ratio of C:(B+A) in the mixture to decrease the refractive index of a coating formed from the mixture.

The coating will preferably have a porosity in excess of 50 v/v %, say in excess of 55, 60, 65, 70, 71, 72, 73 v/v %. The pores may be regular. The pores may have a size of from 1 to 100 nm (which is the definition of mesoporous used herein), e.g. from 1 to 60 nm, for example 2 to 55 nm or 5 to 100 nm, 10 to 95, 15 to 90, 20 to 85, 20 to 80, 75, 65, preferably from 25 to 55 nm. The porous coating may have an inverse opal morphology to accommodate the densest packing of pores in the resulting nano structure.

The photocatalytic particles may be nanoparticles or nanocrystals. The photocatalytic particles may comprise titania. The photocatalytic particles may consist of or comprise titania. The photocatalytic particles may have principal dimensions of less than 10 nm, for example less than 5 nm. The particles may provide up to 75 wt/wt % of the coating, e.g. up to 50 wt/wt %, from 20 to 50 wt/wt %, or from 25 to 50 wt/wt %. The particles may be distributed substantially homogeneously throughout the inorganic skeleton.

The coating may have a refractive index of less than 1.3 at 632 nm or at visible wavelengths. Additionally or alternatively, the coating may have a transmittance of in excess of 90% from 400 to 900 nm on optical or transparent substrates.

The sacrificial polymer of the mixture may be an amphiphillic polymer. The sacrificial polymer may consist of or comprise a block copolymer. The block copolymer may comprise an amphiphilic block sequence, having at least one hydrophilic and one hydrophobic component, where the inorganic sol resides preferentially in one of the blocks due to selective intermolecular forces. Examples include polymer architectures such as diblock poly(A-block-B), triblock poly(A-b-B-b-A, A-b-B-b-C) and starblock copolymers, where A, B, and C are chemically distinct polymer units. The block copolymer may have the form Aₘ-Bₙ-Cₒ, and A is a hydrophobic block, C is a hydrophilic block and B is a linking unit, which may be a polymeric block, and n may be 0 or a positive integer.

The hydrophobic block may be selected from one or more of polyisoprene, polybutadiene, polydimethylsiloxane, methylphenysiloxane, polyacrylates of the C₁ to C₄ alcohols, polymethacrlates of C₃ to C₄ alcohols, poly(ethylene-co-butylene), poly(isobutylene), poly(styrene), poly(propylene oxide), poly(butylene oxide), poly(ethyl ethylene), polylactides, poly(fluorinated styrene), poly(styrene sulfonate), poly(hydroxy styrene) and functional analogues of the same, and is preferably polyisoprene.

The hydrophilic block may be selected from polyethylene oxide, polyvinyl alcohol, polyvinylamines, polyvinylpyridines, polyacrylic acid, polymethacrylic acid, hydrophilic polyacrylates and amides, hydrophilic polymethacrylates and amides and polystyrenesulfonic acids polyaminoacids (e.g. polylysine), polyhyrdoxyethyl-methacrylate or -acrylate, polydimethylamino-ethyl-methacrylate, poly(aminoacids), poly(hydroxyethyl-methacrylate, poly(hydroxyethyl-acrylate, poly(dimethylamino-ethyl-methacrylate), poly(pentamethyldisilylstyrene, poly(saccharides), poly(hydroxylated polyisoprene) and functional analogues of the same, and is preferably polyethylene oxide.

The precursor material may comprise fluorides or oxides and/or species formable into fluorides or oxides. The precursor material may consist of or comprise an inorganic sol. The inorganic sol preferably comprises a transparent matrix material of low refractive index such as oxygen or fluorine containing compounds, preferably alumina (n_{632 nm}=1.77) and/or silica (n_{632 nm}=1.54), most preferably aluminosilicates. Other sols may be used, such as hafnia (n_{500 nm}=1.89), tantalum pentoxide (n_{632 nm}=1.81), calcium fluoride (n_{632 nm}=1.43), magnesium fluoride (n_{632 nm}=1.37) and others. Preferably, the refractive index of the bulk material from which the inorganic skeleton is fabricated will be less than 2, preferably less than 1.95, 1.9, 1.85, 1.8, 1.78, 1.75, 1.70, 1.65, 1.6, 1.59, 1.58, 1.57, 1.56, 1.55.

The photocatalytic particles are typically titania nanocrystals, which may be doped or blended with other materials to improve the photocatalytic activity. Alternative materials systems include tungsten trioxide, zinc oxide, zirconium oxide, cadmium sulfite, or polyoxometallates but titania-based photocatalysts are preferred due to their photostability.

The space filling of voids and passive, low refractive index transparent material in the optical coating is needed as the high refractive index of photocatalytic material would otherwise inhibit the creation of SCARCs on transparent substrates.

A variety of chemical routes can be used to provide a skeleton. For example, silicon or other metal-containing organic compounds, such as alkoxides can be processed in a sol to provide a source of metal or silicon. For example aluminium-sec butoxide in isolation or combination with other species.

Alternatives to alkoxides and halides can be used as precursors for the inorganic material. Examples include (3-Glycidyloxypropyl)trimethoxysilane and other silanes, such as alkyl or aryl silanes, different oxysilanes (ethox, and so on) and other polymeric species, such as poly(methyl silsesquioxane) (PMSSQ) or poly(ureamethylvinyl)silazane (PUMVS), which can be used in isolation or combination.

The ab-initio incorporation of already crystalline photocatalytic particles, such as TiO₂, from solution has several advantages. On the one hand, no high-temperature step during film deposition is necessary to crystallize the TiO₂. Furthermore well-defined photoactive TiO₂ hot spots are formed within the network. While a post-treatment of ARCs with TiO₂ precursor results in additional deposition of material, the present route enables substitutional incorporation. Thus, photocatalytic particles are distributed throughout the structure, for example homogeneously throughout the structure, meaning that upon wear or damage fresh photocatalytic, e.g. titania, spots are uncovered.

The titania particles preferably have a principal dimension of less than 10 nm, preferably less than 5 nm, e.g. less than 4 nm.

The sacrificial polymer may be less than 80 wt/wt %, such as less than 75, 70, 69, 68, 67, 66, 65, say less than 50, e.g. from 10, 11, 12, 13, 14, 15, 16, 17, 18, 19 or 20 to 80 wt/wt %, such as 11 to 78, 12 to 75, 15 to 70 or 16 to 66 wt/wt % of the mixture. The weight ratio of precursor material to polymer in the mixture may be from 10:1 to 1:10, say 5:1 to 1:5, for example from 3:1 to 1:3.

The weight ratio of sol to photocatalytic particles, e.g. titania, in the mixture may be from 10:1 to 1:10, say 5:1 to 1:5, for example from 3:1 to 1:3.

The invention also encompasses substrates provided with such coatings or formed from such mixtures; the substrate may be formed from a mineral or plastics material. For example, the substrate may comprise glass, quartz, indium tin oxide (ITO), transparent polymers (which may be rigid or flexible). The coating may be applied to solar panels or collectors, photovoltaic or other electroluminescent devices, panels, displays, optical equipment (e.g. spectacles, telescopes, microscopes, lenses, reflectors and so on), picture frames, display boxes and so on.

Coating may be achieved by a variety of solution-based deposition techniques such as but not limited to processes coating single substrates like spin coating, dip coating, screen printing, ink-jet printing, pad printing as well as roll-to-roll techniques including knife-over-the-edge coating, meniscus coating, slot die coating, gravure coating, curtain, multilayer slot, slide coating, and roller coating. Other coating techniques like flexographic printing offset lithography, spray coating, electrophotographic, electrographic and magnetographic may become relevant with technological progress.

The method may further comprise annealing or curing the coating at a temperature of less than 250° C., e.g. less than 210° C., 200° C., 175° C., 150° C., 140° C. Additionally or alternatively the method may further comprise removing any solvent prior to step (c). Additionally or alternatively the method may further comprise removing residual polymeric components to leave an inorganic coating.

In this specification the term ‘skeleton’ means a supporting framework, for example a framework structure comprising plural joined and/or inter-connected struts which define spaces therebetween. The framework may be or comprise regular and/or irregular portions. Typically, the coating will be from 80 to 150 nm thick, for example 85 to 145, 90 to 140, 95 to 135, 100 to 130, 105 to 125 nm thick and combinations of respective upper and lower limits. If self-cleaning is the key requirement rather than a combination of self-cleaning and optical transmittance, the coating may be thicker.

### BRIEF DESCRIPTION OF THE DRAWINGS

In order that the invention may be more fully understood, it will now be described, by way of example only, and with reference to the accompanying drawings, in which:

FIG. 1 is a schematic diagram of a process according to the invention;

FIG. 2 is a micrograph of a coating according to the invention

FIGS. 3A-C are micrographs of coatings demonstrating aspects of the invention;

FIG. 4 is a graph showing variation of refractive index with polymer molecular weight;

FIGS. 5A-C are graphs of optical transmittance of coatings demonstrating aspects of the invention;

FIG. 6 is a graph to show the refractive index as a function of titania loading for coatings according to the invention;

FIGS. 7A, B are micrographs of coatings according to the invention;

FIGS. 8A-F are spectra demonstrating the self-cleaning properties of coatings according to the invention;

FIGS. 9A-9C, are graphs showing the rate of reaction for coatings according to the invention; and

FIGS. 10 A-E are photographs showing the self-cleaning capacity of a coating according to the invention.

### DETAILED DESCRIPTION OF PREFERRED EMBODIMENTS

Here, we present a new concept towards the combination of antireflection and photocatalysis, which utilises, in one part, a high molecular weight poly(isoprene-block-ethylene oxide) (PI-b-PEO) block copolymer in combination with silica sol-gel chemistry. A silica (or indeed other inorganic) sol added to a PI-b-PEO solution segregates into the PEO-rich phase.

Spin-coating the polymer-sol solution leads to an inverse-opal-like morphology of the inorganic material, which is indicative of a micellar assembly, potentially aided by the rapid solvent evaporation during film formation.

Subsequent annealing induces the sol-gel condensation reaction, solidifying the film. Finally, the removal of the polymer host by oxygen plasma etching results in robust and continuous inorganic films with n_{c} as low as 1.13. The low value of n_{c} is a consequence of the mesoscopic self-assembled inverse opal structure. The obtained ultralow refractive index films allow the loading of the inorganic silica-based scaffold (up to 50 wt %) with high refractive index photocatalytic particles, for example TiO₂ nanocrystals.

The addition of the nanocrystals to the sol-solution results in their dispersion within the inorganic network. The resulting TiO₂-functionalized ARC has a refractive index, (nₐᵣ≈1.22) appropriate for an ARC and incorporates photocatalytic centres, thereby providing SCC functionality. Moreover, because of the low processing temperatures, the coating is compatible with, inter alia, flexible or rigid plastic substrates.

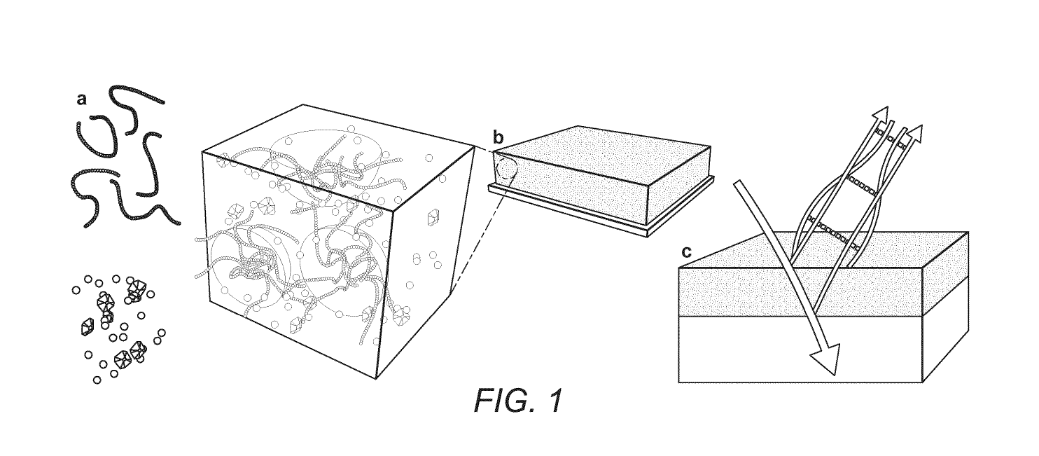

Referring to FIG. 1, there is a schematic of the processing steps of the invention.

A solution of PI-b-PEO block copolymer 1, silica-based sol 2 and TiO₂ nanocrystals 3 is co-deposited on a glass substrate 4 by spin-coating and solvent evaporation to form a nascent coating 5. The inorganic component preferentially resides in the ethylene-oxide phase and is therefore structure-directed during the self-assembly process of the amphiphilic block copolymer. Subsequent reactive etching in an oxygen plasma 6 removes the polymer 7 and reveals an inorganic mesoporous network 8, in which photocatalytic TiO₂ nanocrystals are randomly distributed. Tuning of thickness and refractive index of the optical coating allows phase and amplitude matching to optimise destructive interference of reflected light.

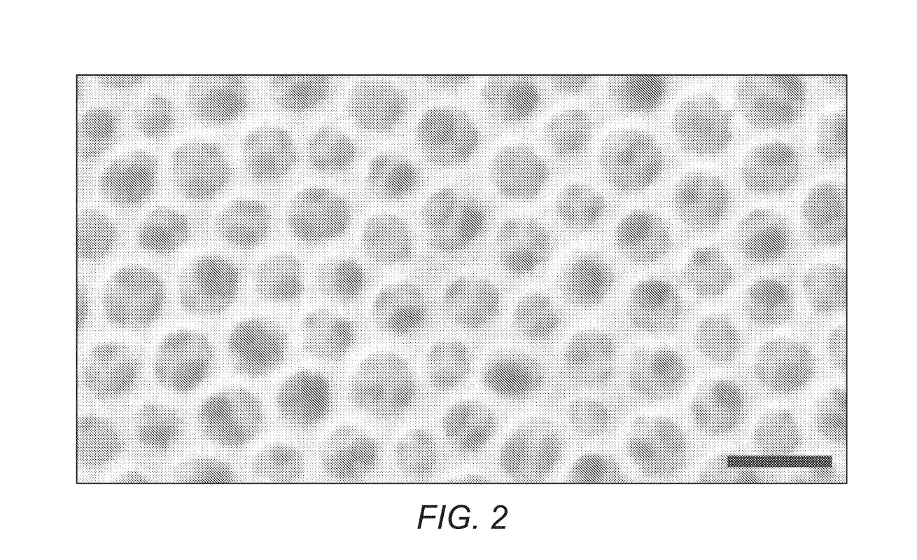

FIG. 2 provides a SEM view of a mesoporous network 8 formed by the invention. The inverse opal-type morphology is clearly shown with an aluminosilcate skeleton 2a in and/or on which TiO₂ crystals are provided, preferably homogeneously dispersed.

In order to further elucidate the invention, reference is made to the accompanying Examples.

### Example 1

### Variation of Porosity

### Preparation of Block Co-Polymer

A high molecular weight block copolymer—poly(isoprene-block-ethylene oxide) (PI-b-PEO) was prepared according to the method of Allgaier et al⁸ and was dissolved in an azeotrope mixture of toluene and 1-butanol. ⁸ Allgaier, J., Poppe, A., Willner, L., and Richter, D. Macromolecules 30, 1582-1586 (1997).

### Preparation of Silica-Based Sol

An aluminosilicate sol was prepared separately by the step-wise hydrolysis of a silicon/aluminium alkoxide mix (9/1 molar ratio), in which: 2.8 g (3-glycidyloxypropyl)trimethoxysilane (98%,Aldrich) and 0.32 g aluminum-tri-sec-butoxide (97%, Aldrich) were mixed with 20 mg KCl (TraceSELECT, Fluka) and promptly placed into an ice bath. In a first hydrolysis step, 0.135 ml of 10 mM HCl was added dropwise in 5 s intervals at 0° C. and stirred for 15 min. After warming to room temperature, 0.85 ml of 10 mM HCl was further added dropwise.

A first set of experiments were conducted to determine the effect of polymer loading on the morphology of the so-formed coating. The organic to inorganic ratio was defined as the ratio between the weight of the polymer in the initial solution and weight of the resulting silica-type material. Polymer loading in the solution was as follows:

| Example | Polymer loading (wt/wt %) |
|---|---|
| 1A | 28 |
| 1B | 40 |
| 1C | 50 |

The components were combined such that the polymer was dissolved in the azeotrope and the TiO₂ solution was added, after stirring of the sol that was added to the hybrid solution.

### Preparation of the Coating on Glass

Hybrid films were deposited onto pre-cleaned glass slides by spin coating (2000 rpm, 20 s). The cast films were annealed on a hotplate by gradually increasing the temperature to 200° C. (180 min linear ramp, 30 min dwell time). In a final step, the organic component of the hybrid films was removed by reactive ion etching in oxygen plasma (30 min, 100 W, 0.33 mbar, STS Instruments, 320PC RIE).

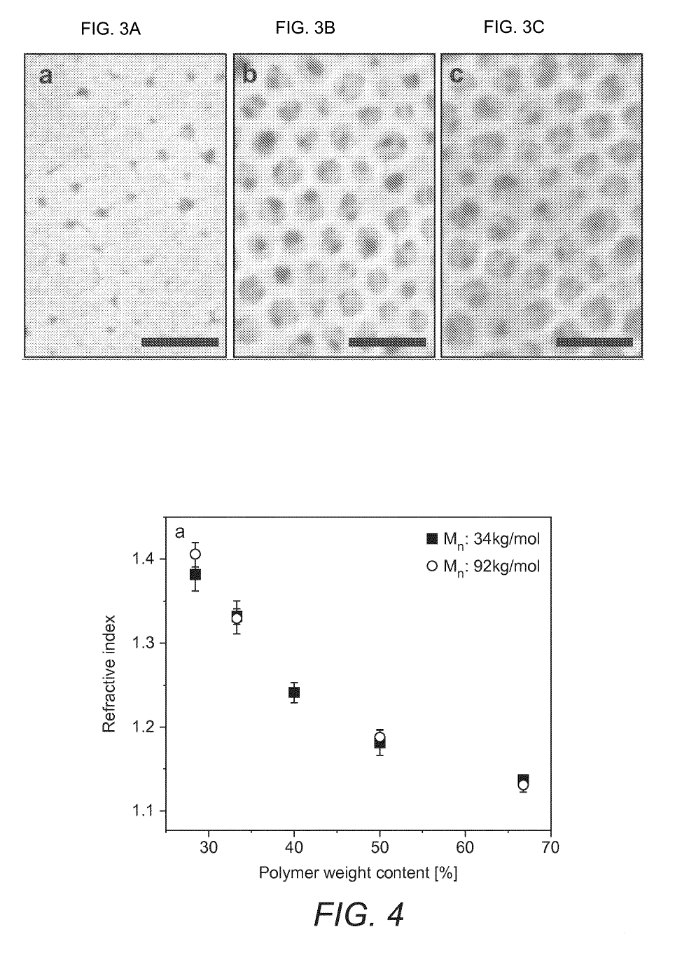

The resulting coatings are shown in FIGS. 3A to C (corresponding to Examples 1A to C).

Scanning electron microscopy shows a skeleton of interconnected struts. The network morphology reveals its likely origin. The well-defined pore size and the local hexagonal arrangement is reminiscent of an inverse opal structure. An inverse opal structure arises from dense packing of sacrificial micelles or colloids. Without wishing to be bound by any theory, we postulate that the evolution of this morphology probably involves the formation of block-copolymer micelles in solution or more specifically a liquid mixture of colloidal, pore forming sacrificial material and network forming inorganic material, which during solvent evaporation self-assemble into an opal morphology consisting of a PI core and a PEO+sol matrix. The condensation reaction and polymer removal then give rise to the network structure in FIG. 3. Since the micellar size is determined by the polymer architecture, a variation of the solid organic to inorganic volume (or weight) fraction allows to fine tune the porosity, while affecting the pore size only very little.

The resulting variation in porosity is shown in FIGS. 3A-C, where the polymer loading was increased from 28 w % to 50 w %. The pore size of the inorganic network can be separately controlled by varying the molecular weight of the sacrificial polyisoprene (PI) block. In this example the PI molecular weight was around 24.8 kg mol⁻¹, which led to a pore size of around 33 nm.

Spectroscopic ellipsometry of the resulting films reveals that the refractive index can be finely tuned in the range 1.40<nₐ<1.13 by varying the polymer weight fraction in the initial solution from 28% to 67% (see FIG. 4).

The Bruggeman effective medium approximation for a network of air voids in an silica-type matrix (n=1.52) reveal 73% porosity for nₐ=1.13.

Because of the very low possible refractive indices, the sol route provides an ideal matrix for inclusion of photocatalytic species (typically of high refractive index) to generate SCARCs.

### Example 2

### Variation of Pore Size

Using the above methodology, it was possible to prepare coatings from solutions fabricated with polymers of different polymer weight content, as follows:

| Example | Polymer | Mn (kg mol⁻¹) | Wt % PEO |
|---|---|---|---|
| 2A | PI-b-PEO34 | 34.4 | 28.0 |
| 2B | PI-b-PEO92 | 91.6 | 31.5 |

FIG. 2 shows the morphology of the film with similar inorganic loading as in Example 1 but with an increased PI molecular weight.

In this Example the copolymer had an increased PI chain length of 62.7 kg mol⁻¹. The increase in chain length resulted in 53 nm-wide pores. This increase is in good agreement with scaling laws governing polymer chains in a good solvent. The radius of gyration of the pore forming PI block scales by a factor of 1.59 when increasing the molecular weight from 24.8 to 62.7 kg mol⁻¹, which is consistent with the pore size determination by SEM image analysis.

### Example 3

### Variation of Chemical Route to Porous Skeleton

In another experiment the materials route to the porous skeleton is altered. Most common pathways for the low refractive index inorganic components involve sol-gel chemistry with hydrolysis and condensation of the precursor chemicals. There are several non-hydrolytic alterations, where the precursor reaction takes place in an organic solvent under the exclusion of water.⁹ ⁹ Sol-Gel Material: Chemistry and Applications, J. D. Wright, N. A. J. M. Sommerdijk, P. O'Brien, D. Phillips, CRC Press, 1st edition (2000)

Instead of following the standard routes of hydrolytic or non-hydrolytic sol-gel chemistry, an alternative precursor material is used, namely poly(methyl silsesquioxane) (PMSSQ) copolymer.¹⁰ In this case the PMSSQ copolymer is dissolved in 1-butanol, mixed with the block copolymer solution. The further processing (annealing and etching) then follows the route explained in Example 1. ¹⁰ S. Kim, J. Cho, K. Char, Langmuir, vol: 23, 6737-6743 (2007)

### Example 4

### Preparation on Plastic Substrates

### Preparation of the Coating on PET

Hybrid films were deposited onto pre-cleaned polyethylene terephthalate (PET) slides by spin coating (2000 rpm, 20 s). The cast films were annealed on a hotplate by gradually increasing the temperature to 130° C. (15 min linear ramp, 5 min dwell time), before the substrates were similarly exposed to 30 min oxygen plasma. For flexible substrates, an aluminium sample holder was built to allow double sided coating.

Using the above techniques, it has been demonstrated that titania or other photocatalytic particles can be incorporated into the coating to imbue the coating with a self-cleaning characteristic. Because it is possible to alter absolute porosity, pore size and photocatalytic particle content it is possible to ‘tune’ the coating such that its refractive index and/or self-cleaning capacity is optimised to a particular use.

### Example 5

### Inclusion of Photocatalytic TiO2 Nanocrystals

A further set of experiments were conducted to investigate the change of coating properties with increasing titania composition. Using the methods set out in relation to Example 1 the following solutions were prepared and formed into coatings to give the detailed TiO2 loading:

### Preparation of TiO₂ Nanocrystals

After stabilisation of a nitrogen atmosphere, the following chemicals were consecutively added to the flask under vigorous stirring: 5.75 ml absolute ethanol, 1 ml TiCl₄, 19.2 ml benzyl alcohol, and 0.23 ml 1,3-propane diol. The solution was heated to 80° C. and stirred for 12 hours. The solute was subsequently precipitated in diethyl ether (1:10 volume ratio) and centrifuged at 3500 rpm for 10 minutes. The resulting wet precipitate was dried for 2 hours in ambient conditions and was then redissolved in an azeotrope solvent mixture of toluene (72.84 wt/wt %) and 1-butanol (27.16 wt/wt %). To maintain consistent concentrations of TiO₂ nanocrystals in the azeotrope solution (20 mg per ml), a fraction of the precipitate was fully dried and heated to 350° to reveal the weight content of TiO₂.

| | | | | TiO₂/ml |
|---|---|---|---|---|
| Example | Polymer/mg | Azeotrope/ml | Sol/mg | (wt/wt % loading) |
| 5A | 50 | 0.7 | 56.0 | 0.50 (25.0) |
| 5B | 50 | 0.5 | 47.0 | 0.70 (37.5) |
| 5C | 50 | 0.6 | 37.5 | 0.94 (50.0) |

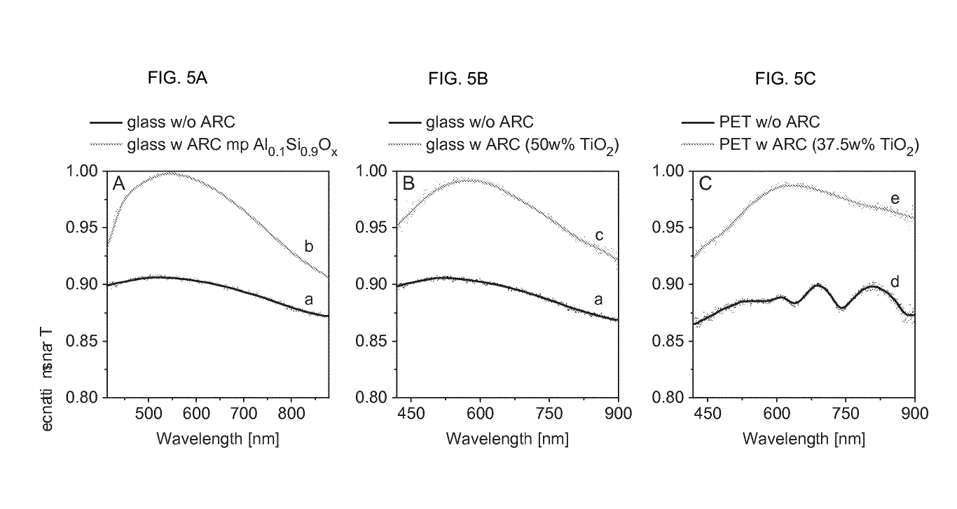

The optical properties of the coatings were investigated. The results are shown in FIGS. 5A and 5B, as follows:

| Line | Substrate | Coating |
|---|---|---|
| a | Glass | None |
| b | Glass | Mesoporous aluminosilicate |
| c | Glass | Mesoporous aluminosilicate; |
| | | 50.0% TiO₂ |
| d | PET | None |
| e | PET | Mesoporous aluminosilicate; |
| | | 37.5% TiO₂ |

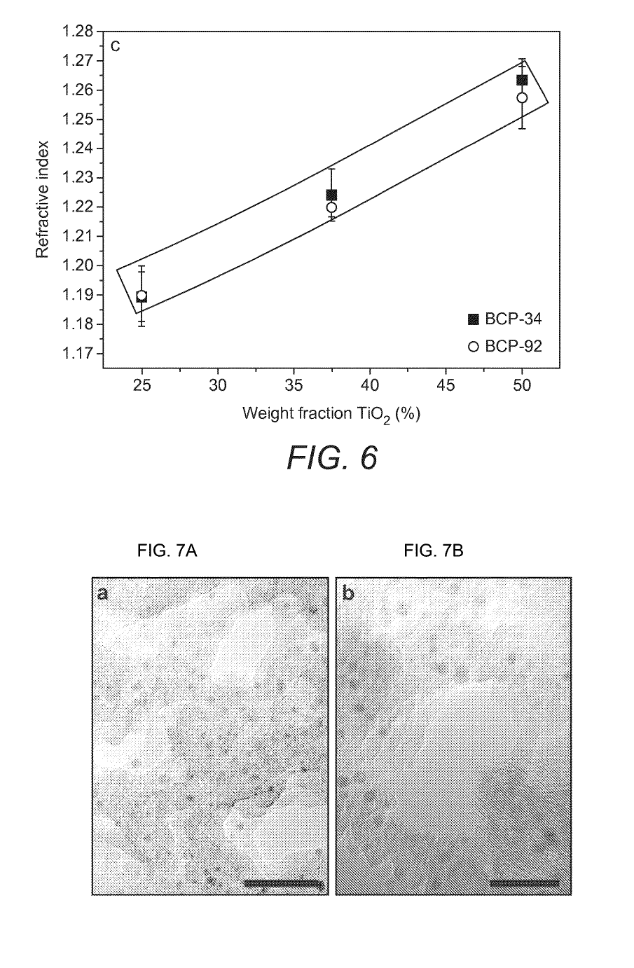

The refractive index of the coatings as a function of wt/wt % TiO₂ loading is shown in FIG. 6.

The refractive index scales well with the replacement of aluminosilicate by TiO₂ calculated using a Bruggeman effective medium approximation. Due to the ≈71% porosity of the inorganic network, up to 50 wt/wt % TiO₂ can be substituted into the silica-type network leading to a refractive index increase from 1.14 (0 wt/wt % TiO₂), to 1.19 (25 wt/wt % TiO₂), 1.22 (37.5 wt/wt % TiO₂), and 1.26 (50 wt/wt % TiO₂) with excellent transmittance and clear (i.e. non coloured) optical properties.

### Example 6

A further set of experiments were conducted to determine the dispersion of TiO₂ nanocrystals in the silica-type matrix.

High magnification transmission electron micrographs were taken for different polymers and 50 wt/wt % TiO₂ loading. The photographs are shown in FIGS. 7A (PI-b-PEO34) and 7B (PI-b-PEO92). The scale bars are 20 nm.

The distribution of the nanocrystals are well dispersed, with nanocrystal dimensions of 3-4 nm. Interestingly and importantly no aggregates were detected. This result was further supported by wide angle x-ray diffraction studies, which demonstrated that the nanocrystal particles sizes were 3.5±0.2 nm, as determined by a Scherrer analysis of the [101] anatase peak.

### Example 7

### Photocatalytic Self-Cleaning of Contaminants

In order to measure the self-cleaning capacity of the coatings a further set of experiments was undertaken.

The decomposition of stearic acid is often used as an organic marker molecule to monitoring of the photo-catalytic performance of self-cleaning surfaces. Stearic acid readily assembles in a homogeneous layer onto inorganic surfaces. Its decomposition can be monitored by Fourier transform infrared spectroscopy (FTIR).

In order to closely mimic solar irradiation (AM 1.5) in the laboratory, we employed a xenon lamp and calibrated the intensity to match the ambient solar power density in the spectral range λ<375 nm, where TiO₂ absorbs light due to the anatase band gap of ≈3.3 eV.

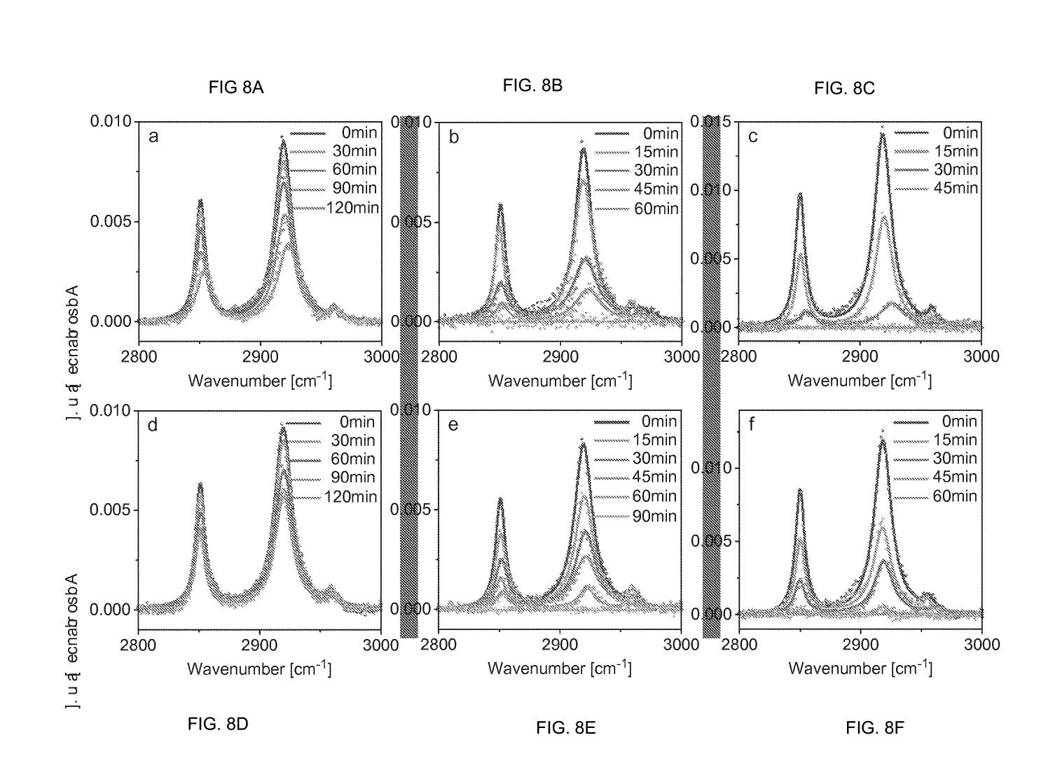

FIGS. 8A-F shows the decomposition of stearic acid adsorbed onto ARCs of two different pore sizes (a-c: 33 nm; d-f: 53 nm), each with TiO₂ loadings of 25-50 wt/wt %. FTIR absorbance spectra were collected in transmission and baseline corrected. In the spectral range from 2800-3000 cm⁻¹ stearic acid shows three peaks: the asymmetric in-plane C—H methyl stretching results in absorbance at 2958 cm⁻¹, while the 2923 cm⁻¹ and 2853 cm⁻¹ peaks correspond to symmetric and asymmetric C—H stretching modes of CH2, respectively. The integrated area under all three peaks, normalized to the value before irradiation, was used as a measure of the stearic stability on the SCARC surfaces.

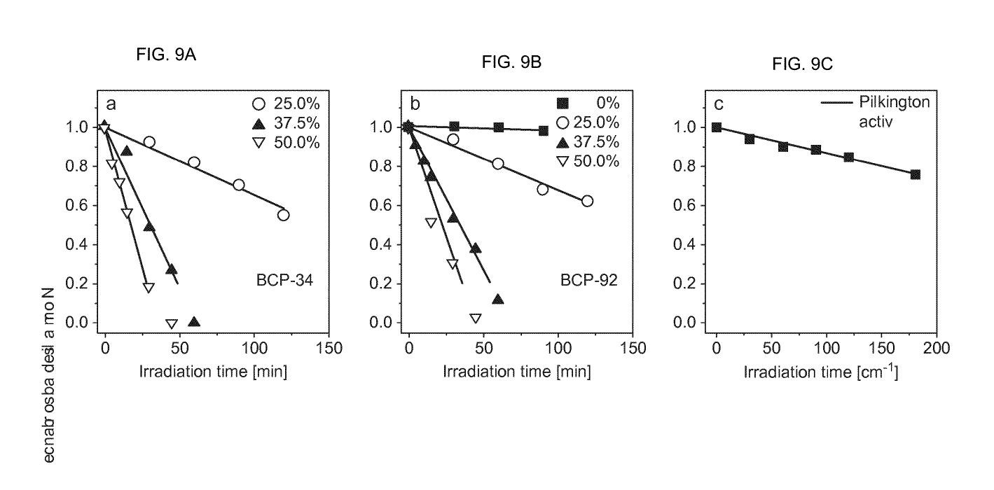

While stearic acid decomposition for samples with 25 wt % TiO₂ loading was relatively slow, the FTIR signal decreased rapidly for samples with 37.5 and 50 wt/wt % TiO₂. The kinetics of the integrated peak decay exhibited zeroth-order reaction characteristics for all samples. (see FIG. 9, with FIG. 9A for PI-b-PEO34, pore size≈33 nm and FIG. 9A for PI-b-PEO92, pore size≈53 nm). For the larger TiO₂ loadings (i.e. 37.5 and 50.0 wt/wt %), it appears that the smaller pore sample outperforms the larger pore sample (i.e. a lower time constant).

Results of the various experiments are shown below:

| | | reaction rate (×10¹³ |
|---|---|---|
| Sample | TiO₂ (wt/wt %) | molecules/min) |
| PI-b-PEO34 | 50.0 | 4.71 |
| PI-b-PEO92 | 50.0 | 3.32 |
| PI-b-PEO34 | 37.5 | 2.53 |
| PI-b-PEO92 | 37.5 | 1.54 |
| Prior Art¹¹ | | 0.15 |

¹¹“Activ” marketed by Pilkington Glass, which is not an ARC

As a comparison, an equivalent experiment was conducted for a stearic acid coated pure aluminosilicate reference and no decrease in FTIR absorbance was shown after 3 hours of irradiation. A Prior Art reference sample exhibit a significantly slower reaction rate with 0.15×10¹³ molecules/min.

### Example 8

### Photocatalytic Removal of Fingerprint Residues

To demonstrate the capability of the optical coatings to maintain functionality under severe macroscopic contamination, samples were polluted with fingerprints and exposed to simulated sunlight (AM1.5).

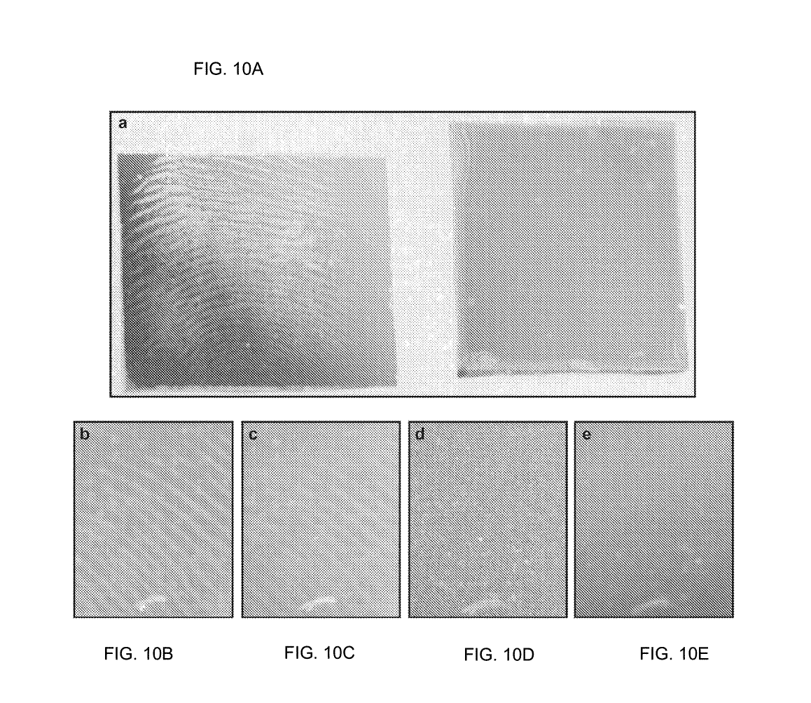

For comparison, a bare silicon substrate was compared to a silicon substrate that has been previously coated with the self-cleaning antireflective coating described above. An identical fingerprint was initially applied to both samples. In FIG. 10 the optical appearance of previously contaminated samples is compared after 120 min of simulated solar irradiation. The neat silicon sample (a) still exhibits macroscopic contamination where the outline of the fingerprint is well discernible. In contrast, the sample coated in accordance with the invention has fully recovered from the contamination and visibly shows no signs of remaining residues. The temporal evolution of the self-cleaning mechanism is shown in FIG. 10 b-e.

The photographs show a sample coated with self-cleaning antireflective coating in the various stages of the self-cleaning process, i.e. (a) after application of the fingerprint, (b) after 30 min, (c) after 60 min, and (d) after 120 min of simulated sunlight. While the samples (a) have not been exposed to any further treatment, the sample pictured in b-d was exposed after 60 min to a short spill of water to simulate further wash off by rain. The comparison between samples in (a) and (e) shows that whilst washing may further support the self-cleaning process it is not necessary.

Of course, by the coating exhibiting self-cleaning properties without requiring further agents (e.g. water) many more possible uses (e.g. indoor and or water sensitive environments) are afforded the coating.

In summary, the current invention has clearly demonstrated that it is possible to make an effective SCARC which has a useful refractive index and optical transmittance characteristics. It is also clear that it is possible to tune the various characteristics of the coating to adapt it for a wide range of uses. Moreover, because of the absence of a high temperature annealing step, it is possible to use the coating of the invention on a wide range of substrates, e.g. plastics (both rigid and flexible) and glass.

The demonstration that washing is not needed to ensure self-cleaning means that the coating can be deployed in a wide range of moisture sensitive environments.

1-42. (canceled)

43. A self-cleaning anti-reflecting coating for a substrate, the coating comprising a mesoporous inorganic skeleton having photocatalytic particles provided therein and/or thereon, the coating having a thickness of 80 to 150 nm, having a porosity in excess of 50 v/v %, having an optical transmittance in excess of 90% from 400 to 900 nm on a transparent substrate and having a refractive index of less than 1.35 at visible wavelengths, wherein the photocatalytic particles provide from 25 to 75 wt/wt % of the coating.

44. A coating according to claim 43, having a porosity in excess of 55 v/v %.

45. A coating according to claim 43, wherein the refractive index is less than 1.3 at visible wavelengths.

46. A coating according to claim 43, wherein the pores have a size from 10 to 95 nm.

47. A coating according to claim 43, wherein the photocatalytic particles have principal dimensions of less than 10 nm.

48. A coating according to claim 43, wherein the photocatalytic particles provide from 25 to 50 wt/wt % of the coating.

49. A coating according to claim 43, wherein the photocatalytic particles are distributed substantially homogenously throughout the inorganic skeleton.

50. A coating according to claim 43, wherein the distribution of the photocatalytic particles is well dispersed.

51. A coating according to claim 43, whereas the inorganic skeleton having an inverse opal-type morphology.

52. A coating according to claim 43, whereas an amphiphilic polymer is used in the method of making the coating.

53. A coating according to claim 43, whereas a block copolymer is used having at least one hydrophilic and one hydropholic components.

54. A coating according to claim 43, whereas the inverse opal structure arises from dense packing of sacrificial micelles or colloids.

55. A coating according to claim 43, wherein the hydropholic block is selected from one or more of polyisoprene, polybutadiene, polydimethylsiloxane, methylphenylsiloxane, polyacrylates of the C1 to C4 alcohols, polymethacrylates of C3 to C4 alcohols, poly(ethylene-co-butylene), poly(isobutylene), poly(styrene), poly(butylene oxide), poly(ethyl ethylene), polylactides, poly(fluorinated styrene), poly(hydroxy styrene).

56. A coating according to claim 43, wherein the hydrophilic block is selected from one or more of polyethylene oxide, polyvinyl alcohol, polyvinylamines, polyvinylpyridines, polyacrylic acid, polymethacrylic acid, hydrophilic polyacrylates and amides, hydrophilic polymethacrylates and amides and polystyrenesulfonic acids, poly(aminoacids), poly(hydroxyethyl-methacrylate, poly(hydroxyethyl-acrylate, poly(dimethylamino-ethyl-methacrylate), poly(pentamethyldisilylstyrene, poly(saccharides), poly(hydroxylated polyisoprene).

57. A method of making a self-cleaning anti-reflecting coating according to claim 43, the method comprising the steps of:
a) Combining to form a mixture
A solution of a sacrificial polymer
A precursor material formable into an inorganic skeleton
Photocatalytic nanocrystals
b) Solution processing the mixture to provide a coating on a substrate, and
c) Annealing or curing the coating
wherein the sacrificial polymer comprises an amphiphilic block copolymer.

58. A method of tuning the refractive index of a self-cleaning anti-reflecting coating, the method comprising combining to form a mixture including:
A solution of a sacrificial polymer (component A)
A precursor material formable into an inorganic skeleton (component B)
Photocatalytic nanocrystals (component C)
and increasing the weight ratio of A:(B+C) and/or decreasing the weight ratio of C:(B+A) in the mixture to decrease the refractive index of a coating formed from the mixture wherein component A comprises an amphiphilic block copolymer.
